(19) United States
(12) Patent Application Publication
(10) Pub. No.: US 2023/0046267 A1
(43) Pub. Date: Feb. 16, 2023

(54) METHOD FOR DISCHARGING MIXED COMPONENTS

(71) Applicant: Marco Systemanalyse und Entwicklung GmbH, Dachau (DE)

(72) Inventor: Martin Reuter, Dachau (DE)

(21) Appl. No.: 17/883,913

(22) Filed: Aug. 9, 2022

(30) Foreign Application Priority Data
Aug. 13, 2021 (DE) 10 2021 121 124.7

(51) Int. Cl. B01F 35/75; B01F 29/15

(52) U.S. Cl. CPC B01F 35/75425; B01F 29/15; B01F 2215/0431

(57) ABSTRACT

In a method for discharging components that are mixed in a centrifugal mixer, a mixing cup is provided that is closed by a piston and that is subsequently pivoted.

The invention relates to a method for discharging components mixed in a centrifugal mixer.

So-called centrifugal mixers are used in the prior art for mixing different fluid components, by which centrifugal mixers the components are mixed with one another in mixing cups while utilizing centrifugal forces and are also degassed, if necessary. In this respect, the problem arises that the components at the base of the mixing cup are not mixed or are not mixed completely, e.g. since a cup receiver extends into the interior of the mixing cup at the center of the base. If the mixing cup has to be refilled to discharge the mixture, bubbles can additionally occur and further equipment will be wetted, which results in media losses and additional expenditure.

It is the object of the invention to provide a method for discharging mixed components and a corresponding apparatus by which a discharge of the mixed components is possible in a cost-efficient manner.

This object is satisfied by the features of the independent claims. Advantageous embodiments are described in the description and in the dependent claims.

In the method in accordance with the invention, a mixing cup can be used that is ideally designed for the mixing. This means, for example, that the effective height of the mixing cup amounts to approximately 1.5 to 2 times its diameter. In this respect, an effective height is understood as a maximum filling height that can be used without restrictions in operation.

To discharge the mixed components from the mixing cup, a piston with an integrated outlet is used in accordance with the invention, wherein an apparatus with an integrated distance measurement can be provided that enables a precise volumetric metering in that the piston is moved relative to the mixing cup to discharge the mixed components through the outlet.

In the method in accordance with the invention, a mixing cup can be filled with two or more components with the aid of volumetric pumps. The mixing cup preferably has a cylindrical side wall with a radius between the base and the side wall. The mixing cup filled with the components can then be set into rotation in a centrifugal mixer so that the components mix intimately and uniformly. In this respect, after the mixing, the side walls of the mixing cup are, however, also wetted with the mixed medium above the upper level. If, in accordance with the invention, a piston, which tightly contacts the inner wall of the mixing cup with its outer wall, is inserted into the interior of the mixing cup in this state, the wetted medium can be wiped off on the insertion of the piston. At the same time, air beneath the piston, i.e. between the piston and the medium, is expelled through the outlet of the piston when the piston is pressed into the interior of the mixing cup.

It can be advantageous if the piston and/or the outlet or an outlet stub molded to the piston is/are produced from a translucent material since the path of the medium through the piston or through the outlet or the outlet stub can then be monitored. An automation can hereby take place by a monitoring device.

It can also be advantageous if an outlet stub molded to the piston has a length that is greater than the height or the effective height of the mixing cup. The outlet is hereby also located outside the mixing cup when the piston is completely pressed into the mixing cup.

If a piston with a pipe stub is used, the channel within the pipe stub can be selected so narrow that, on a pivoting of the mixing cup by 180°, the medium located within the mixing cup cannot escape through the channel by itself and no air can move into the interior of the mixing cup again either.

After the pivoting of the mixing cup, it can be inserted into an expulsion apparatus. In this apparatus, a press plunger can press onto the piston, wherein the press plunger can be driven in a path-controlled manner, whereby a precise volume can be precisely metered.

The present invention will be explained purely by way of example in the following with reference to an advantageous embodiment. There are shown:

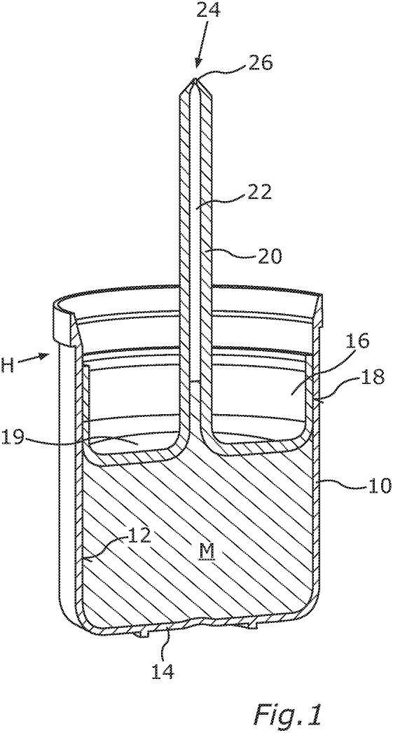

FIG. 1 a sectional view through a mixing cup closed by a piston; and

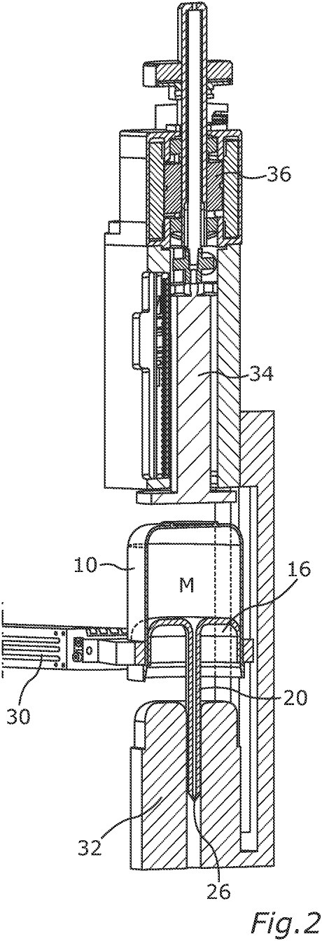

FIG. 2 a sectional view through an expulsion apparatus.

FIG. 1 shows an upwardly open mixing cup 10 in section that is cylindrical and generally U-shaped in the longitudinal section and that has a cylindrical inner wall 12 and a substantially planar base 14, wherein the base 14 merges via a radius into the inner wall 12. A piston 16 is inserted from above into the mixing cup 10 and tightly closes the mixing cup in that the piston 16 tightly contacts the inner wall 12 of the mixing cup 10 with its outer wall 18. The height of the piston wall or of the outer wall 18 corresponds to approximately 25 to 30%, in particular approximately 30% of the effective filling height H of the mixing cup.

A pipe stub 20 is molded on at the center of the piston 16 at its outer side, which does not face into the interior of the mixing cup, and forms an outlet channel 22 that extends from a piston base 19 up to an outlet 24 that is formed by a narrowed nozzle opening 26.

As FIG. 1 illustrates, a medium M, which is formed by the mixing of two components, for example in a centrifugal mixer, is located between the base 14 of the mixing cup 10 and the piston base 19 of the piston 16. Other mixers can naturally also be used. If the piston 16 is moved relative to the mixing cup 10 in the direction of the base 14, air present above the medium M first escapes through the outlet passage 22 and the medium M is subsequently expelled through the outlet passage 22.

FIG. 2 shows an expulsion apparatus, wherein the mixing cup 10 is held by a robot gripper 30 and has been pivoted by 180° so that the outlet 26 no longer faces upwardly, but faces perpendicular downwardly. The mixing cup 10 can subsequently be moved further downwardly by the robot gripper 30 until the upper side of an anvil 32 dips into the interior of the piston 16 until the latter is disposed on the anvil 32. To expel the medium M from the mixing cup 10, a press plunger 34 is furthermore provided that is driven by a stepper motor 36 via a spindle, wherein an angular encoder is provided so that the angle of rotation and thus also the stroke of the press plunger 34 can be precisely detected and controlled. For this purpose, an electronic control is provided that can also be connected to a device for image acquisition that detects the expulsion of the medium from the mixing cup 10 through the stub 20 and thereby controls the driving of the press plunger 34. The drive motor 36 itself has a hollow shaft having a thread via which a threaded rod is driven that, at the lower end, has a linear guide having a magnet that detects the absolute position of the press plunger 34 via Hall sensors. The press plunger 34 is connected beneath the magnet via a threaded rod.

When the piston 16 is disposed on the anvil 32, the robot gripper 30 can be retracted and the press plunger 34 can be moved vertically downwardly so that it moves the mixing cup 10 relative to the stationary piston 16 such that the medium is expelled through the outlet passage 22 within the pipe stub 20 and leaves the outlet 24 through the nozzle opening 26 at the lower end of the pipe stub 20.

1. A method for discharging components mixed in a centrifugal mixer, comprising the following steps:
providing an upwardly open mixing cup in which at least two components mixed in a centrifugal mixer are located,
closing the mixing cup with a piston that is provided with an outlet,
pivoting the mixing cup such that the outlet faces downwardly, and
displacing the piston within the mixing cup so that the contents of the mixing cup exit from the outlet.

2. The method in accordance with claim 1,
wherein a piston is used whose outlet is arranged at the end of a pipe stub.

3. The method in accordance with claim 2,
wherein the pipe stub is longer than the mixing cup is high.

4. The method in accordance with claim 1,
wherein the outlet is formed by a nozzle opening.

5. The method in accordance with claim 1,
wherein the space closed by the piston is vented by the outlet by a relative movement between the piston and the mixing cup.

6. The method in accordance with claim 1,
wherein the piston is held in a stationary manner and the mixing cup is displaced in the direction of the piston.

7. The method in accordance with claim 1,
wherein the displacement is effected by a press plunger that is moved by a drive monitored by a control.

8. A mixing cup, which is closed by a piston, for performing a method for discharging components mixed in a centrifugal mixer,
wherein the mixing cup is U-shaped in the longitudinal section,
the piston tightly contacts the inner wall of the mixing cup with its outer wall, and
a stub having an outlet channel is attached to the piston, said outlet channel connecting the interior of the mixing cup to an outlet provided at the end of the stub.

9. The mixing cup in accordance with claim 8, wherein the method comprises the following steps:
providing the mixing cup that is upwardly open in which mixing cup at least two components mixable in a centrifugal mixer are located,
closing the mixing cup with the piston that is provided with an outlet,
pivoting the mixing cup such that the outlet faces downwardly, and
displacing the piston within the mixing cup so that the contents of the mixing cup exit from the outlet.

10. The mixing cup in accordance with claim 8,
wherein the outlet is formed by a nozzle.

11. The mixing cup in accordance with claim 8,
wherein the stub is arranged at the center of the piston.

12. The mixing cup in accordance with claim 8,
wherein a length of the stub is greater than a height respectively an effective height of the mixing cup.

13. The mixing cup in accordance with claim 8,
wherein the wall of the piston extends over approximately 30 - 40% of the effective mixing cup height.
